(19) United States
(12) Patent Application Publication
(10) Pub. No.: US 2012/0175823 A1
(43) Pub. Date: Jul. 12, 2012

(54) SYSTEM AND PROCESS FOR CREATING AN EXTRUDED POLYPROPYLENE PERIMETER EXTENDING FRAME FOR A VEHICLE HEADLINER HAVING DYNAMIC FRACTURE CAPABILITIES TO REDUCE INJURY

(75) Inventors: Kevin Charles Baxter, Goodrich, MI (US); Kevin Weingartz, Imlay City, MI (US)

(73) Assignee: U.S. FARATHANE CORPORATION, Auburn Hills, MI (US)

(21) Appl. No.: 13/348,725

(22) Filed: Jan. 12, 2012

Related U.S. Application Data
(60) Provisional application No. 61/431,936, filed on Jan. 12, 2011.

(51) Int. Cl. B29C 47/76; B29C 47/34

(52) U.S. Cl. 264/571; 425/403.1

(57) ABSTRACT

A system and process for forming an impact absorbing vehicle headliner extrusion including feeding a viscous polymeric material to an extrusion chamber, introducing a vacuum into an interior of the chamber, progressively forming the material into an extruded shape by subsequently passed through a series of sizer dies positioned at communicating interior locations along the chamber, and drawing an extruded profile out of the chamber prior to bending and forming into an overall closed profile. Pluralities of structural supporting ribs are formed within an open interior of the extruded profile. The chamber is separated into a front vacuum tank incorporating a first plurality of sizer dies and an interconnecting rear vacuum tank incorporating a second plurality of sizer dies for assisting in the formation of the ribs within a hollow interior profile associated with the extruded article.

### CROSS REFERENCE TO RELATED APPLICATIONS

The application claims the benefit of Provisional Patent Application No. 61/431,936, filed Jan. 12, 2011.

### FIELD OF THE INVENTION

The present invention relates generally to an extruded and control collapsible material, such as is incorporated into a vehicle headliner. More specifically, the present invention discloses a system, assembly and manufacturing process for creating an extruded polymeric vehicle interior headliner with control collapse features incorporated therein, and which replaces prior art injection molded headliners. The extruded headliner can be formed, by non-limiting example, from such as polypropylene and which, in response to an impact causing an occupant's head to travel forwardly into contact with the headline, operates to reduce or eliminate injury. A controlled atmospheric chamber is utilized with the extrusion process for ensuring proper quality and formation of the headliner.

### DESCRIPTION OF THE BACKGROUND ART

The prior art is well documented with examples of vehicle headliner profiles and assemblies, such as which extend around an inner and underside perimeter of a vehicle roof and which, in instances of vehicle collisions, can provide a degree of impact protection to such as an occupants head. Examples of typical headliner assemblies include such as the thermoformable polymeric foam headliner as taught by Maurer, Jr., U.S. Pat. No. 4,600,621, the head impact energy absorbing member of Song et al., U.S. Pat. No. 6,234,526, the thermoformable laminate including rigid thermoplastic foam sheet of Erickson, U.S. Pat. No. 6,368,702, the headliner having integrated energy absorbing foam of Gorowicz, U.S. Pat. No. 7,261,933, and the energy absorbing impact structure of Fox et al., U.S. Pat. No. 6,779,835. Corresponding processes or methods for constructing such an energy absorbing headliner are further represented by example in Preisler et al., U.S. Pat. No. 7,182,908, Cormier et al., U.S. Pat. No. 7,384,095 and Gorowicz et al., U.S. Pat. No. 6,500,369.

### SUMMARY OF THE PRESENT INVENTION

The present invention teaches a process for forming an impact absorbing vehicle headliner extrusion including the steps of feeding a viscous polymeric material to an extrusion chamber, introducing a vacuum into an interior of the chamber, progressively forming the material into an extruded shape by subsequently passed through a series of sizer dies positioned at communicating interior locations along the chamber, and drawing an extruded profile out of the chamber prior to bending and forming into an overall closed profile. Additional steps include forming any plurality of ribs within an open interior of the extruded profile as well as of separating the chamber into a front vacuum tank incorporating a first plurality of sizer dies and an interconnecting rear vacuum tank incorporating a second plurality of sizer dies.

An associated system for creating the extruded polymeric composition similarly includes a vacuum induced chamber exhibiting a lengthwise extending interior within which are positioned a series of sizer dies and an elongated supporting structure including rollers extending between supporting sides and upon which is supported an elongate extruded article withdrawn from the chamber. The chamber further includes a front vacuum tank incorporating a first plurality of sizer dies and an interconnecting rear vacuum tank incorporating a second plurality of sizer dies. As with the corresponding process, the sizer dies exhibit inner template profiles for assisting in the formation of structural supporting ribs within a hollow interior profile associated with the extruded article.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration in perspective of a pair of cutaway slices of headliner extrusion formed in a process according to the present invention and including a first generally rectangular shaped slice and a second generally hour glass shaped slice;

FIG. 2 is a succeeding end plan view of the headliner extrusion slices depicted in FIG. 1;

FIG. 3 is an overhead plan view of a generally rectangular shaped and closed perimeter headliner extrusion formed according to the process of the present invention;

FIGS. 4A-4D are a series of illustrations of interconnected front and rear vacuum tanks collectively forming a vacuum chamber associated with the extruder headliner forming process;

FIGS. 5A-5B are a further pair of illustrations depicting the formed polypropylene extrusion passing through an end wall aperture associated with the rear vacuum tank and prior to subsequent bending and closed perimeter forming operations;

FIGS. 6A-6D depict an extrusion slice of vehicle headliner of further variation similar to that previously shown in FIGS. 1 and 2 and forming through a plurality of successive progression phases;

FIGS. 7A-7C, similar to FIG. 3, depict another possible configuration of closed perimeter formed headliner extrusion of generally rectangular configuration through a series of three progression steps; and

FIGS. 8A-8C, similar to FIGS. 7A-7C, depict a yet further possible configuration of vehicle headliner extrusion of generally square shaped configuration through a series of progression steps.

### DETAILED DESCRIPTION OF THE PREFERRED EMBODIMENTS

As previously described, the present invention discloses a manufacturing process for creating an extruded polymeric vehicle interior headliner with control collapse features incorporated therein, and which replaces prior art injection molded headliners. The extruded headliner can be formed, by non-limiting example, from such as polypropylene and which, in response to an impact causing an occupant's head to travel forwardly into contact with the headline, operates to reduce or eliminate injury. As will be described in further detail, a controlled atmospheric chamber is utilized with the extrusion process for ensuring proper quality and formation of the headliner.

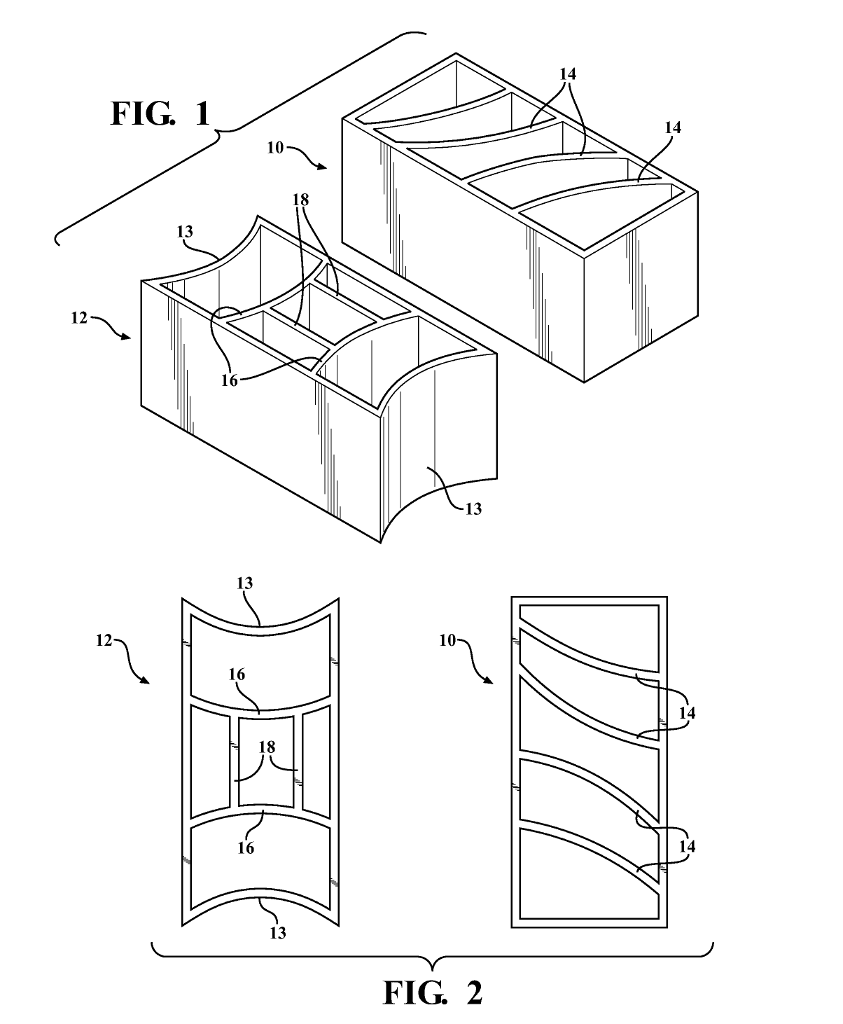

Referring first to FIG. 1, a pair of illustrations are generally provided at 10 and 12, respectively, in perspective of a pair of cutaway slices of headliner extrusion formed in a process according to the present invention. Specifically, slice 10 depicts a generally rectangular cross sectional shape with four outer interconnected sides. Corresponding slice 12 exhibits in cross section an overall similar and irregular rectangular profile with the exception of reformed and hourglass shaped ends 13. FIG. 2 further depicts a succeeding end plan view of the headliner extrusion slices 10 and 12 depicted in FIG. 1.

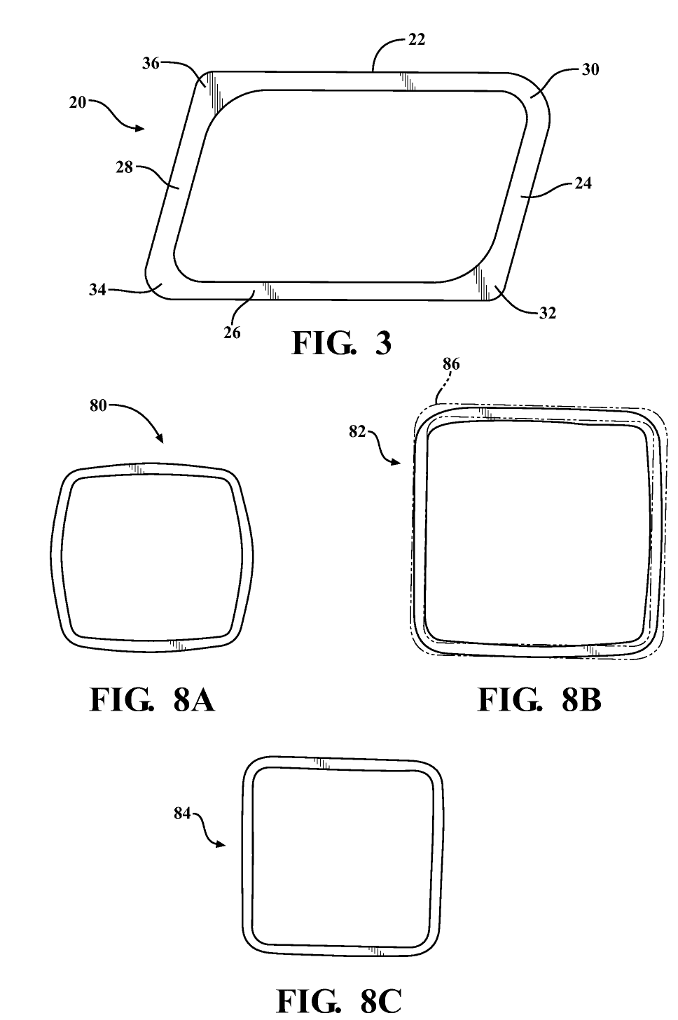

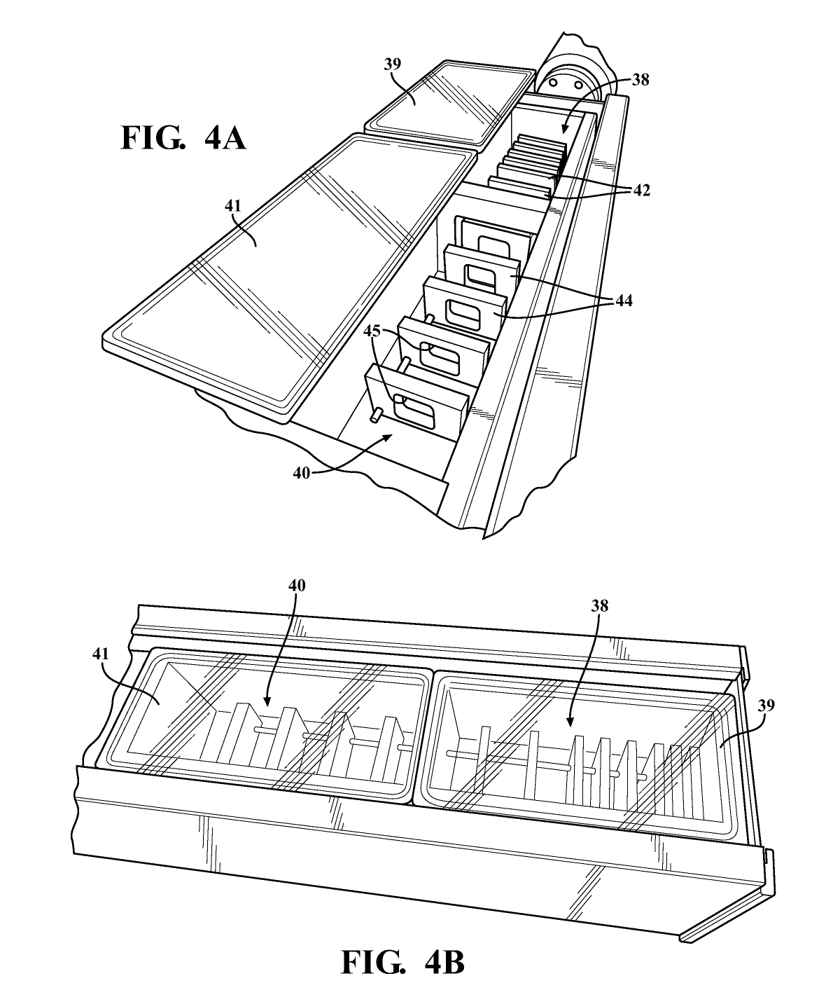

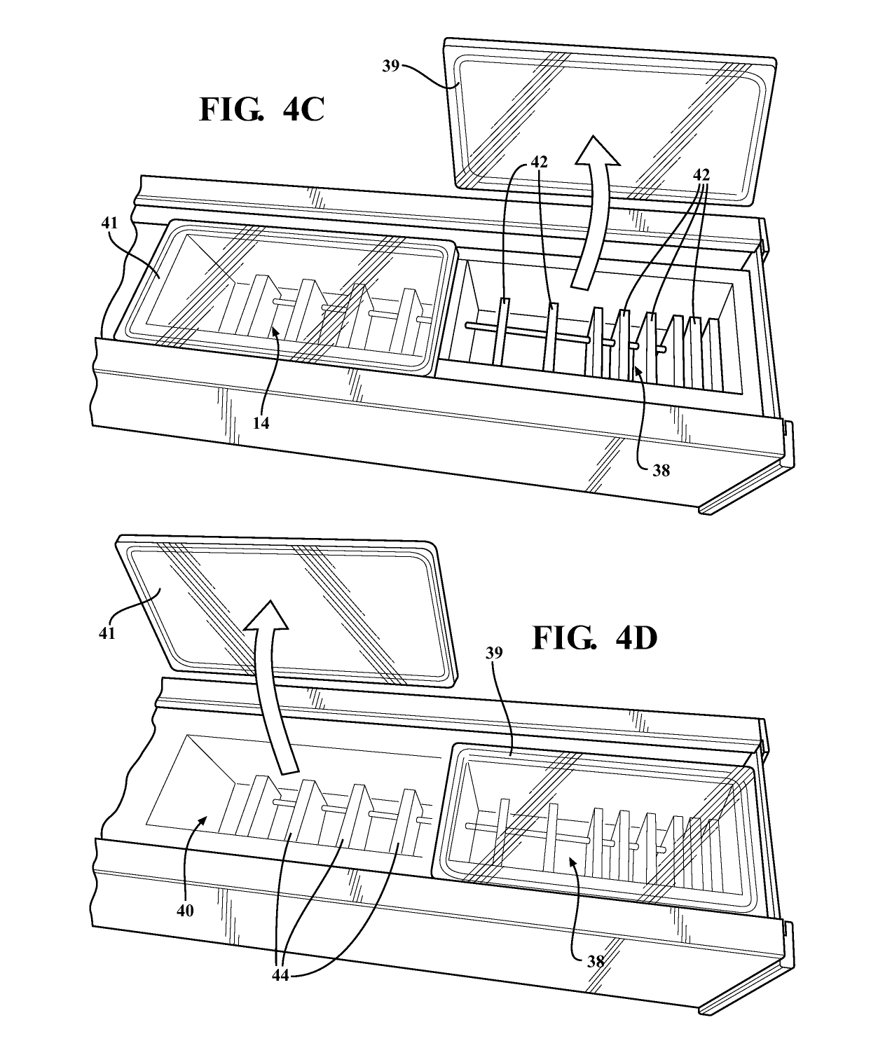

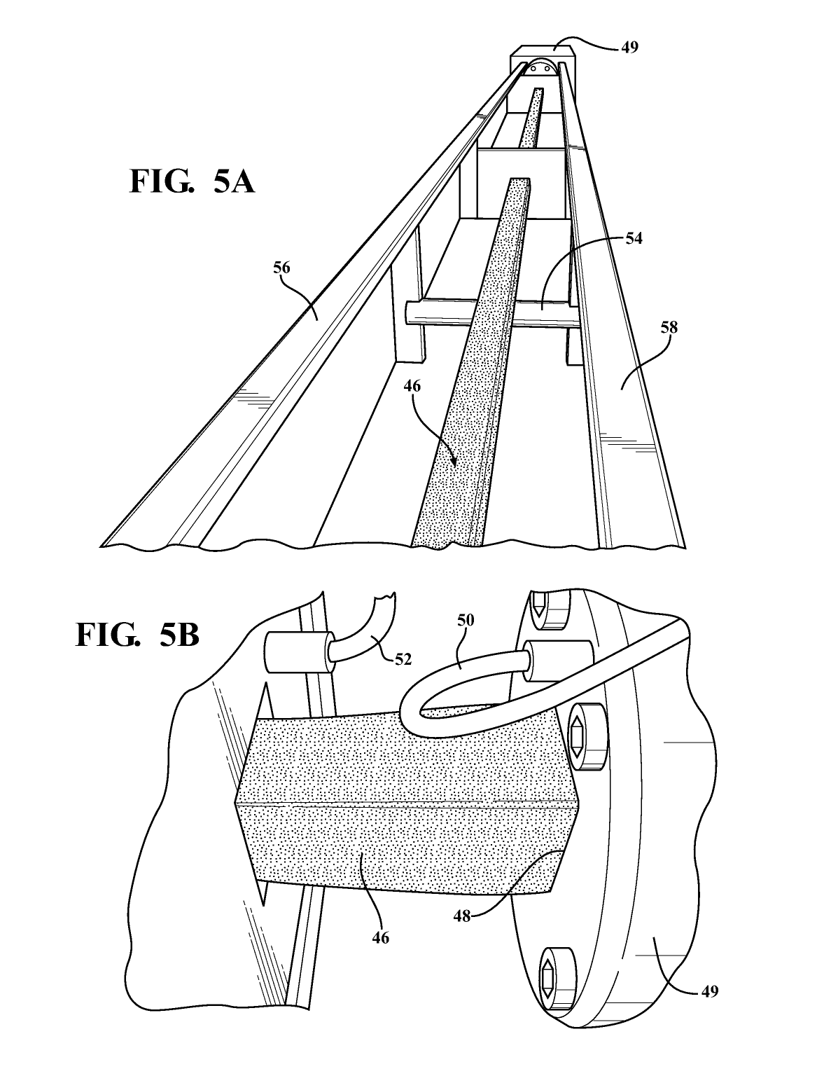

As will be further described in reference to FIGS. 4-5, the head impact profile extrusion (HIPE) is formed of a polypropylene or other suitable polymeric material. The examples 10 and 12 of the profile slices are designed to exhibit a desired outer cross sectional dimension, such as further identified in the illustration of FIG. 3 and which can depict, in one non-limiting application, a sizing such as at 40 mm×50 mm×250 mm with a corresponding wall thickness of the extrusion at 2.0-2.5 mm.

The examples 10 and 12 of the cross sectional profile extrusions each further include an interior architecture defined by a designed plurality of inner extending and selectively structural strengthening/reinforcing ribs, these formed according to any desired pattern or arrangement and in the desire to modulate the control collapse characteristics of the profile in response to an impact event. As depicted in the non-limiting illustrative examples, the profile 10 exhibits a plurality of generally arcuate/angled ribs 14 extending between first and second longer sides and further such as in non-parallel extending fashion relative to the shorter ends.

The profile 12 depicts an alternate strengthening rib configuration in which a pair of outer and arcuate spaced ribs, each shown at 16, are bridged by additional crosswise extending inner structural ribs further depicted at 18. The various outer walls and inner ribs defining each profile slice 10 and 12 can, in one non-limiting application, exhibit an average wall thickness of 1.4 mm however, and without limitation, any variation or configuration of the outer walls and/or inner/interconnecting or reinforcing ribs can be adjusted according to length, angle and/or thickness to any size without limitation.

Referring now to FIG. 3, an overhead plan view is generally depicted at 20 of a generally rectangular shaped and closed perimeter headliner extrusion formed according to one non-limiting version of the process of the present invention. The nature of the extrusion process, as further described in FIGS. 4 and 5, is such that the individual outer perimeter dimensions of the polypropylene extruded article can be varied in dimension and profile at each of its sides 22, 24, 26 and 28 and alternating corners 30, 32, 34 and 36 and such that the overall headliner extrusion created is dimensioned for inter-fitting within a specific headliner pocket or receiving space defined in a vehicle roof underside (not shown). Although not shown, the extrusion is provided as a linear article of selected overall dimension, which is subsequently bent and joined end to end in order to create a desired perimeter profile.

Referring now to FIGS. 4A-4D, a series of illustrations are provided of interconnected front 38 and rear 40 vacuum tanks, these collectively forming a vacuum chamber associated with the extruder headliner forming process, and further such as which are fed by a plurality of hoses and fittings (not shown) which assist in creating a negative pressure environment within the tanks . Each of the tanks 38 and 40 include a (transparent) lid or cover (at 39 and 41 respectively) and such as which reveals an interior depicted by individual pluralities 42 (FIG. 4C) and 44 (FIG. 4D) of sizer dies positioned respectively within the front 38 and rear 40 tanks in order to assist in the successive and linearly drawn extrusion of the desired profile article.

The individual sizer dies 42 and 44 exhibit varying internal apertures (see for example inner profiles 45 associated with selected dies 44 located within the rear vacuum tank 40) and which, upon being aligned/realigned according to a desired pattern, result in the formation of an overall profile extrusion such as is depicted in three dimensional cross section the various illustrations depicted by non-limiting example in FIGS. 1-3. Without limitation, the sizer dies 42 and/or 44 can exhibiting increasing or decreasing dimensioned extrusion profiles (e.g. again at 45) and, in addition to creating a vacuum environment within either or both the front 38 and rear 40 interconnecting tanks defining the overall vacuum chamber, it is further envisioned that the vacuum conditions created can vary in both atmospheric condition (such as between the front and rear tanks) and, optionally, in the addition of secondary chemical gases or the like in order to affect the formation of the extrusion as well as potentially to coat or otherwise treat the extrusion.

FIGS. 5A-5B present a further pair of illustrations depicting a formed polypropylene extrusion 46 passing through an end wall aperture 48 associated with the overall extruder assembly generally depicted at 49, and such as again prior to bending and closed perimeter forming operations for creating a closed perimeter profile as depicted in FIG. 3. The illustration of FIG. 5B further partially illustrates the valves and hoses (see at 50 and 52) which are employed in creating the desired vacuum and modified internal environment within the overall vacuum chamber.

Additionally not shown are polymeric material feed stock lines (one or more) which are utilized in order to deliver the correct volume of such as a viscous feed material to the vacuum chamber in order to initiate the extrusion formation process. In this fashion, the finished extrusion 46 is continuously drawn through the outlet of such as the rear chamber 40 and, while typically in a pre-hardened state, is conveyed upon an elongated supporting structure including rollers 54 (FIG. 5A) and between supporting sides 56 and 58 for forming into its desired closed profile.

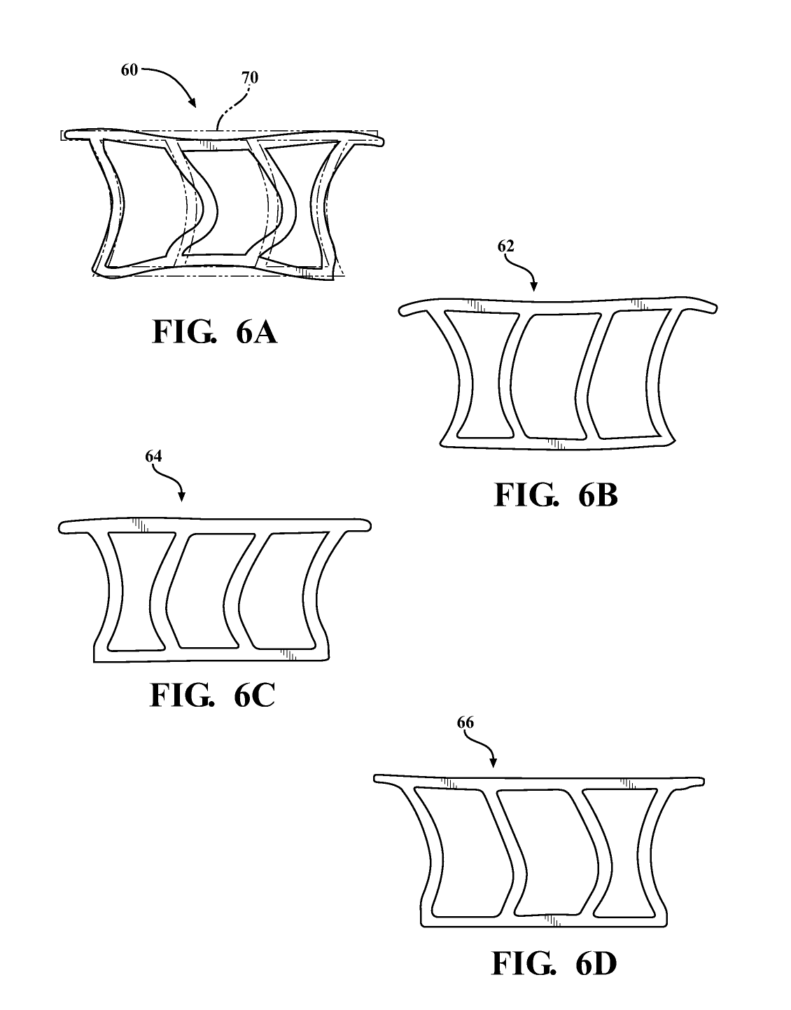

FIGS. 6A-6D depict an extrusion slice of vehicle headliner according to a further variation similar to that previously shown in the examples of 10 and 12 in each of FIGS. 1 and 2. Specifically, a cross sectional depiction of a selected headliner slice (initially depicted by selected slice 60 in FIG. 6A) is manipulated/formed through a plurality of successive progression phases, see again at each of 62, 64 and 66 corresponding to succeeding FIGS. 6B, 6C and 6D and corresponding to the individual pluralities of successively placed dies associated with the front and rear interconnected tanks of the vacuum chamber to create a desired and closed perimeter headliner such as shown (in non-limiting fashion) previously in FIG. 3. Of additional note, FIG. 6A depicts (in phantom at 70) outer trace a desired profile which is more or less achieved in the concluding phase or depiction 66 (FIG. 6D).

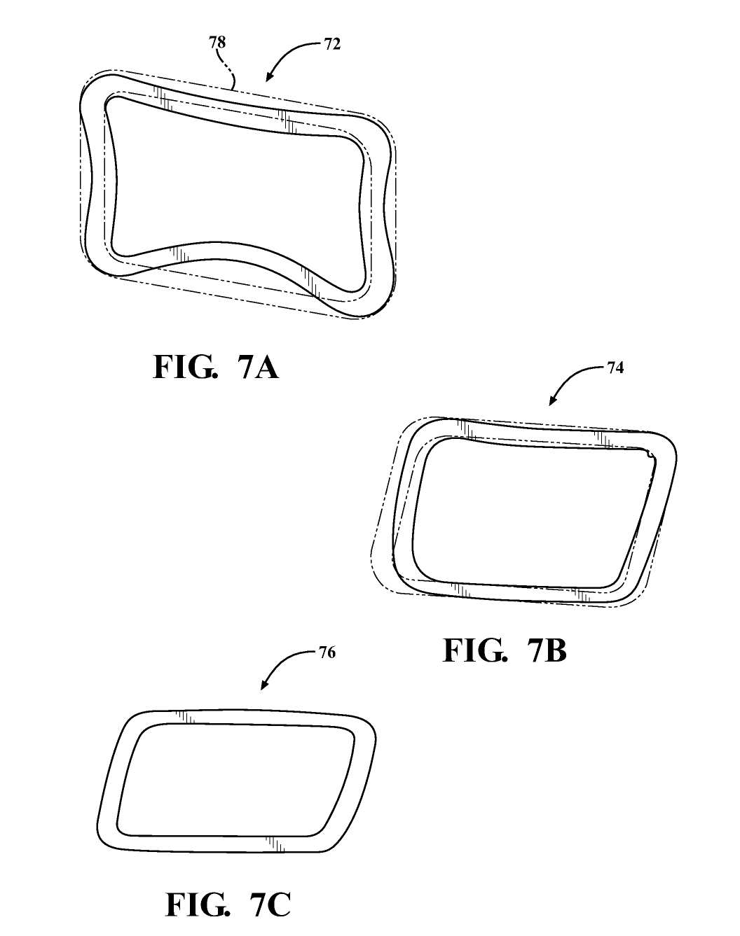

FIGS. 7A-7C, are similar to FIG. 3 and depict another possible configuration of closed perimeter formed headliner extrusion (see at 72 in FIG. 7A) of generally rectangular configuration and through a series of three progression steps (further at 74 in FIG. 7B and concluding at 76 in FIG. 7C). As with the previous example of FIGS. 6A and 6D, a phantom depiction 78 in FIG. 7A illustrates the eventual formed profile of the extrusion likewise generally depicted at 76 in FIG. 7C. Without limitation, the closed perimeter profile can reference either or both a closed cutaway section of an extrusion slice (such as not including inner structural ribs) and/or an overall closed and headliner defining perimeter (similar again to FIG. 3).

Finally, FIGS. 8A-8C, similar to FIGS. 7A-7C, depict a yet further possible configuration of vehicle headliner extrusion 80 exhibiting a generally square shaped configuration through a series of progression steps and which can be formed with the assistance of a dual vacuum tank as depicted in FIG. 4. As with the previous examples of FIGS. 6 and 7, this includes the initial profile 80 of FIG. 8A being initially modified (via associated extrusion dies) to that further depicted generally at 82 in FIG. 8B (phase 2) and, ultimately, to that shown at 84 in FIG. 8C and corresponding to a phase 3 depiction resulting from implementation of the dual stage vacuum tank as previously described (with phantom depiction 86 of FIG. 8B corresponding again to the eventual profile outline 84).

Accordingly, the present invention discloses a head impact profile extrusion (HIPE) developed with a base material exhibiting optional sizes and profiles utilizing a specific atmospheric forming chamber. Such extruded parts are created as part of an HIC requirement in a specified (e.g. automotive) headliner application. The process for creating the extruded design is further an improvement over prior art injection molded headliners in that it provides lower cost in materials, processing, and cooling in the creation of the extrusion profile exhibiting any variation in outer dimension and inner structural rib configuration, such as which it is also contemplated can be further varied at varied longitudinal (length) locations along the formed extrusion.

Having described my invention, other and additional preferred embodiments will become apparent to those skilled in the art to which it pertains, and without deviating from the scope of the appended claims.

We claim:

1. A process for forming an extrusion, comprising the steps of:
feeding a viscous polymeric material to an extrusion chamber;
introducing a vacuum into an interior of the chamber;
progressively forming the material into an extruded shape by subsequently passed through a series of sizer dies positioned at communicating interior locations along the chamber; and
drawing an extruded profile out of the chamber prior to bending and forming into an overall closed profile.

2. The process as defined in claim 1, further comprising the step of forming any plurality of ribs within an open interior of the extruded profile.

3. The process as defined in claim 1, further comprising the step of separating the chamber into a front vacuum tank incorporating a first plurality of sizer dies and an interconnecting rear vacuum tank incorporating a second plurality of sizer dies.

4. A system for creating an extruded polymeric composition, comprising:
a vacuum induced chamber exhibiting a lengthwise extending interior within which are positioned a series of sizer dies; and
an elongated supporting structure including rollers extending between supporting sides and upon which is supported an elongate extruded article withdrawn from said chamber.

5. The system as described in claim 4, said chamber further comprising a front vacuum tank incorporating a first plurality of sizer dies and an interconnecting rear vacuum tank incorporating a second plurality of sizer dies.

6. The system as described in claim 4, said sizer dies exhibiting inner template profiles for assisting in the formation of structural supporting ribs within a hollow interior profile associated with said extruded article.

7. A process for forming an extrusion, comprising the steps of:
feeding a viscous polymeric material to an extrusion chamber;
introducing a vacuum into an interior of the chamber;
progressively forming the material into an extruded shape by subsequently passed through a series of sizer dies positioned at communicating interior locations along the chamber;
separating the chamber into a front vacuum tank incorporating a first plurality of sizer dies and an interconnecting rear vacuum tank incorporating a second plurality of sizer dies; and
drawing an extruded profile out of the chamber prior to bending and forming into an overall closed profile.

8. The process as defined in claim 7, further comprising the step of forming an extrusion exhibiting in cross section any rectangular or irregular rectangular shape exhibiting a four sided outer profile and within an open interior of which are provided a plurality of at least one of lengthwise and crosswise extending ribs in order to achieve desired mechanical and deformable properties.
